(19) United States
(12) Patent Application Publication
(10) Pub. No.: US 2011/0167660 A1
(43) Pub. Date: Jul. 14, 2011

(54) Flat lay-out tape

(76) Inventor: Brady M. Furrow, Roanoke, VA (US)

(21) Appl. No.: 12/655,877

(22) Filed: Jan. 8, 2010

(51) Int. Cl. G01B 3/10

(52) U.S. Cl. 33/759; 33/770

(57) ABSTRACT

A flat lay-out tape for roofers that eliminates errors and saves time in striking chalk lines for aligning rows of shingles. The flat design allows the tape to lay flush against the roof surface, which facilitates accurate measuring and striking. The lay-out tape prevents errors by providing simple, easy to follow row indicators on the tape. In the preferred embodiment, row indicators for architectural shingles are provided. In operation, a nose hook at the end of a lay-out tape is hooked over the drip edge of a roof and the tape is extended over the apex of the roof. The nose hook has a shape that is complementary to that of the drip edge and the hook resists becoming unattached from the edge even when pulled straight up. The same operation is done with a second lay-out tape, near the opposite side edge of the roof. A chalk line is then stretched across the two tapes, and chalk lines are struck between corresponding indicators of the two lay-out tapes. The present invention eliminates the need for manually markings on the roof, and prevents the tape from becoming prematurely unattached to the edge of the roof.

This application is related to U.S. Provisional Patent Application Ser. No. 60/______,______ filed on May 18, 2009, and priority is claimed to the provisional application.

### BACKGROUND OF THE INVENTION

The present invention relates generally to the field of roofing equipment and more specifically to a lay-out tape that assists in laying out straight rows of shingles.

The majority of residential houses have shingle roofs. Shingles are relatively small weather resistant pieces of material that are attached, in an overlapping pattern, to the tops of houses to provide protection from the elements. The most popular style of roofing shingles is the architectural shingle. The present invention is designed solely for use with architectural shingles. Rows of architectural shingles are spaced 5½ inches apart on a roof. The traditional method of pre-marking rows of shingles involves the use of a standard measuring tape. The measuring tape is stretched from the bottom of the roof, to the top of the roof, and marks are manually made on the roof surface every 5½ inches, for architectural shingles. This process is repeated on the opposite end of the roof and chalk lines are struck between corresponding marks to create chalk lines for the rows of shingles. This traditional method however has many problems. Continually adding 5½ to a previous number to come up with the next marking position on the measuring tape is difficult, even for roofers that are good with numbers, and erroneous marks are not uncommon. Also, manually placing the large number of required marks on both sides of a roof is very time consuming. Further, standard measuring tapes are beveled and do not lay flush against a roof, thereby making precise marks difficult to achieve. Beveled tapes also tend to slide easily on flat surfaces such as a roof thereby adding to the difficulties. To make matters worse, a standard measuring tape only has an “L” shaped hook at its end, which does not allow the tape to remain securely attached to the edge of the roof. Moreover, the edges of roofs comprise a rounded attachment called a drip edge that prevents water from seeping under the roof, but also makes attachment of a tape measure to the roof's edge very difficult.

What is needed in the field is a lay-out tape that is specifically designed for laying out rows of shingles on a roof. The ideal tape would have a flat surface so that it could lay flush with the roof surface and allow for precise striking of chalk lines. The ideal tape would also have an improved tip that would not easily come unhooked from the drip edge of a roof. Furthermore, an ideal shingle lay-out tape would have easy to read indicia for architectural shingles, so that confusion about which mark to follow would be eliminated. Such a device would not only save time, but also provide more accurate chalk (lay-out) lines for the rows of shingles.

### SUMMARY OF THE INVENTION

A flat, lay-out tape that assists roofers in laying out rows of shingles on a roof. The lay-out tape saves time by eliminating the need for hundreds of manual markings on the roof, and eliminates most marking errors by having only one set of indicators on any one side of the tape. The flat, lay-out tape comprises a housing and a flat metal tape that is rolled in a coil while inside the housing. The housing has a tough, durable exterior that protects the tape and other items stored in the interior of the housing. The housing includes a slotted opening, for passage of the tape, and at least part of the tape's rewind mechanism. The interior end of the tape is attached to the rewind mechanism and the exterior end of the tape at least partially extends outside of the slotted opening in the housing. In the preferred embodiment, the external tip of the tape is in the shape of semi-circle that allows the tip to completely encompass the drip edge of the roof. The rewind mechanism is preferably an automatic mechanism that allows the tape to be recoiled with minimal effort from the roofer. A locking mechanism is provided to lock the tape in place after it has been extended the desired distance. The housing is preferably made of a hard plastic material and the tape made from a durable material, such as metal.

It is an object of the present invention to drastically reduce the amount of time required to make lay-out lines for rows of shingle by eliminating the need for hundreds of manual markings.

It is another object of the present invention to provide an improved tip, or nose hook, that allows the tape to securely attached to the drip edge of a roof and that prevents the tape from becoming unattached unintentionally.

It is yet another object of the present invention to provide a lay-out tape that lays flush against any flat surface so that accurate line striking is achievable.

It is still a further object of the present invention to provide a durable lay-out tape that can be used over and over.

### BRIEF DESCRIPTION OF THE DRAWINGS

The invention of the present application will be described in detail with reference to the accompanying drawing(s), given only by way of example, in which:

FIG. 1 is a side view of the preferred embodiment with the improved tip;

FIG. 2 shows the present nose hook in operational position, latched onto the drip edge of a roof;

FIG. 3 shows a traditional “L” shaped tip in operational position, attempting to latch onto the drip edge of a roof;

FIG. 4 shows the markings provided on the flat surface of the preferred embodiment; and,

FIG. 5 illustrates how the present lay-out tape can be used to strike lines on a roof without the need to pre-mark the roof.

### DETAILED DESCRIPTION OF THE INVENTION

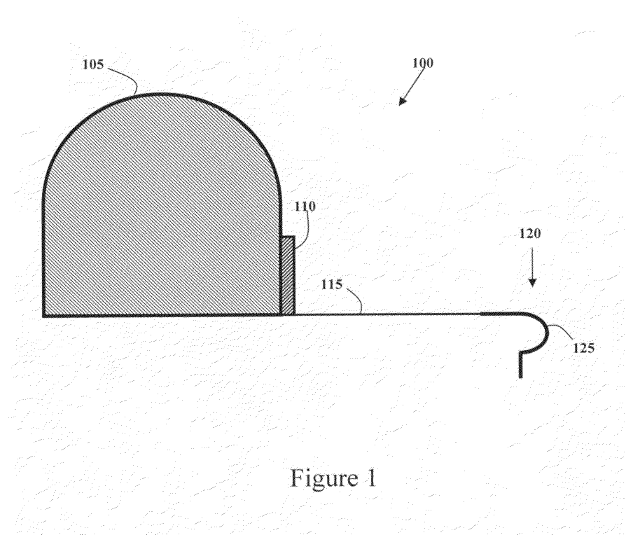

FIG. 1 shows a second alternative embodiment 100 of the present flat layout tape. The improved feature of this embodiment 100 is the nose hook 120 which is located at the exterior end of the tape 115. The nose hook 120 is designed with a complete semi-circle 125 that allows the end of the tape to hook on to the drip edge of the roof. This feature allows the present tape to latch on to the edge of the roof and not be pulled off, or become unattached due to wind or because of extended pulling and unwinding of the tape. Prior tapes with a classic “L” shaped tip at the end may hook on to an edge of a roof, however, by the time the roofer has walked half way up the roof, the “L” shaped hook often times becomes un-hooked; either because of the angle at which the tape is being pulled is too extreme or because the wind has gotten under the tape and pulled the hook off of the roof's edge. The present layout tape 115 and nose hook 120 avoids both of these problems. Firstly, the tape 115 is flat, so it is very hard for wind to get under the tape and dislodge the tape. Secondly, the semi-circle portion 125 of the nose hook 120 wraps around the drip edge of the roof and prevents the hook from becoming dislodged, even when the tape is pulled and extended at extreme angles.

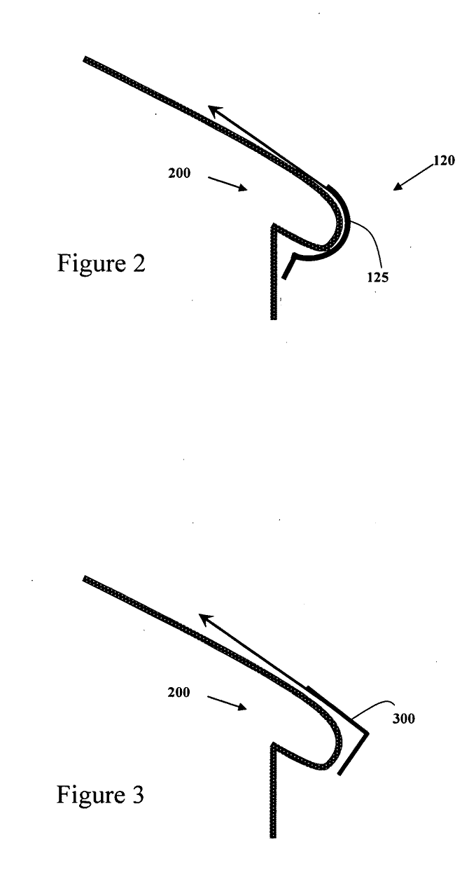

FIG. 2 shows the present nose hook 120 latched onto the drip edge 200 of a roof. The semi-circle 125 of the nose hook 120 provides the tip of the present tape with a shape that is complementary to that of the drip edge 200. This complementary shape allows the entire drip edge to fit within the present nose hook 120. Thus, after attaching the nose hook 120, the roofer can pull upward on the tape and the nose hook will not become unattached. The roofer is then free to walk, as fast as he wants, up to the apex of the roof, and he does not have to worry about the tip of the present layout tape coming disconnected from the drip edge. Once at the top of the roof, the roofer can pull on the present tape to make it form a straight line up to the apex. Pulling and aligning the tape to straighten it out, at the top of the roof, is possible because of the improved latching ability provided by the novel nose hook 120 of the present invention.

FIG. 3 helps illustrate the tremendous advantage the nose hook of the present invention has over traditional tape measures. The bottom edges of roofs today typically have what is called a drip edge 200 attached to them, over which the first row of shingles are laid. The drip edge 200 does not provide a nice flat surface for the tip of a traditional tape measure to latch onto. FIG. 3 illustrates the problem that occurs when a traditional tape measure with an “L” shaped tip 300 attempts to latch onto the drip edge 200. The flat surfaces of the “L” shaped tip 300 simply do not match well with the rounded surface of the drip edge 200. As a result, the traditional “L” shaped tip slips off of the drip edge 200 upon the slightest movement or disturbance. Unfortunately, in roofing, there is always movement of the tape after the tip is latched over the drip edge, as the roofer must walk up to the apex of the roof in order to unwind and layout the tape. After getting frustrated by having to re-attach the tip to the drip edge several times, it is not unusual for roofers to have an assistant hold the tip on the drip edge while he walks up to apex of the roof. This is obviously not an efficient use of manpower during a roofing job.

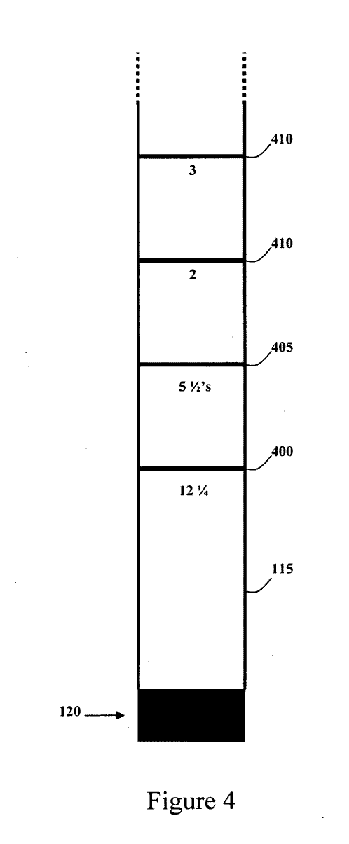

FIG. 4 shows the simplified markings 400, 405 & 410 on the second embodiment. These indicia provide first markings 400 and follow on markings 405 & 410 that show where chalk lines should be struck for the rows of shingles. These simplified markings 400, 405 & 410 are exemplary only, and are used herein to illustrate an embodiment that is extremely user friendly to roofers. The initial first marking 400 includes an indication that the mark is 12¼ inches from the edge of the tape. This assures the roofer that the present tape is for use with architectural shingles. The second marking 405 reminds the roofer that all subsequent markings 410 will be 5½ inches apart, the required spacing for architectural shingles. Since roofers often prefer to strike chalk lines for every other row of shingles, and they prefer to count in even numbers, the next row indicator 410 is labeled “2”. Using every other of the follow-on markings 410, the roofer is allowed to strike chalk lines at the markings with even numbers, i.e., indicators 2, 4, 6, etc. As mentioned above, the present invention eliminates the need for physically marking the roof with indicators for chalk strike lines. Because of the flat design of the present tape, the roofer can strike chalk lines right over the top of the present tape. The chalk lines will be complete lines except for the small area under the line of chalk that the tape takes up, which is negligible.

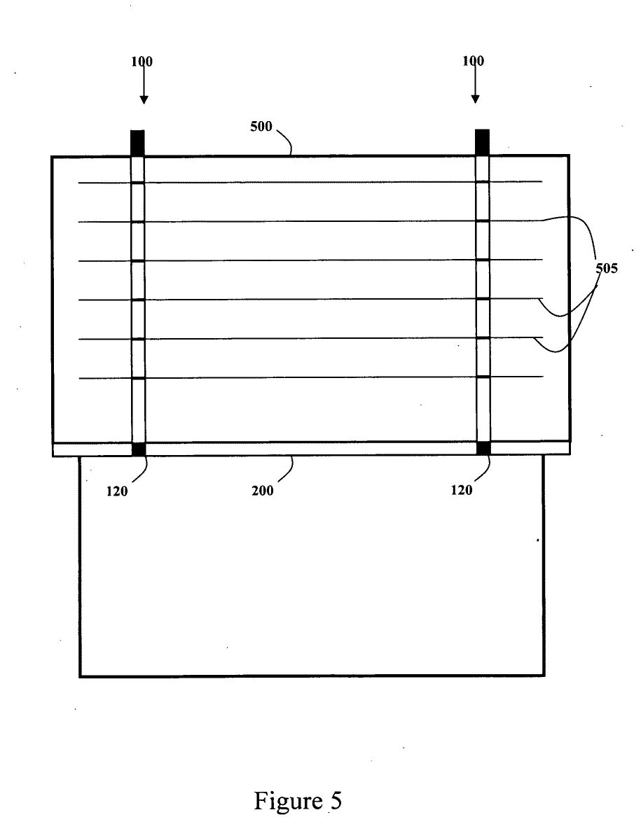

FIG. 5 shows two of the present lay-out tapes 100 in operation, on the roof 500 of a house. Standing on one side of the roof, near the bottom edge of the roof, the roofer pulls a length of tape out of the housing and drops the nose hook 120 over the edge of the roof. The nose hook is allowed to engage with, and latch on to, the drip edge 200 of the roof and roofer walks up to the apex of the roof, allowing the tape to unwind from the housing as he walks. At the apex, the roofer engages the locking mechanism and lays the housing over the apex. The weight of the tape and housing are enough to keep the tape in place during marking. The roofer then repeats this process near the other end of the roof, and chalk lines 505 are ready to be struck. In the old, traditional method, the roofer would need to make tick marks on the roof, every 5½ inches, next to the tape. The present invention totally eliminates this time consuming, labor intensive step. The flat design of the present tape, and the thick, easily seen indicia on the tape, allow chalk lines to be struck right over the tape. The first chalk line is struck over the 12½ indicator on the tape. And, chalk lines are struck over each indicator after that. After the last chalk line is struck, up near the apex of the roof, the tapes are retracted into their housings and the process of nailing shingles to the roof is ready to begin. The present invention is specifically designed to benefit roofers by reducing the number steps required in the roofing processing, thereby saving time and labor.

The foregoing description of the specific embodiments will so fully reveal the general nature of the invention that others, can, by applying current knowledge, readily modify and/or adapt for various applications such specific embodiments without departing from the generic concept. For example, spacing indicators for shingles other than architectural and standard shingles could be provided on the lay-out tape. The lay-out tape could also provide spacing indicia for other types of roofing materials, such as ceramic tiles. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A flat lay-out tape that is adapted to assist roofers in laying out rows of shingles on a roof, wherein the lay-out tape saves time by eliminating the need for multiple manual markings by allowing chalk line striking directly over the tape, and eliminates marking errors by having mark indicators for only one type of shingle, the flat lay-out tape comprising:
a housing, the housing having a durable exterior surface that provides protection to items in an interior of the housing, wherein the housing includes a slotted opening, and at least part of a rewind mechanism is centrally located in the interior of the housing;
a flat tape that includes row indicator markings for a roofing shingle, wherein the tape further includes an interior end that is attached to the rewind mechanism and an exterior end that at least partially extends outside of the opening in the housing; and,
a nose hook, wherein the nose hook is attached to the exterior end of the tape and includes a section that is complementary in shape to a drip edge of the roof, so that the drip edge is able to completely fit within the nose hook and the nose hook resists becoming unattached from the drip edge even when the tape is pulled upward.

2. The flat lay-out tape of claim 1, wherein the row indicator markings include a first marking 12¼ inches from the exterior end of the tape, and multiple subsequent markings, each subsequent marking being 5½ inches from a previous marking.

3. The flat lay-out tape of claim 1, wherein the housing is primarily made of a hard plastic material and the tape is made from a durable material, including metal and fiberglass.

4. The flat lay-out tape of claim 1, wherein the section of the nose hook that is complementary in shape to the drip edge is in a shape of a semi-circle, and the nose hook further includes a thumb tab that is attached to the semi-circle.

5. A flat lay-out tape that is adapted to assist roofers in laying out rows of shingles on a roof, wherein the lay-out tape saves time by eliminating the need for multiple manual markings on the roof by allowing chalk line striking directly over the tape, and eliminates marking errors by only having mark indicators for one type of shingle on the tape, the flat lay-out tape comprising:
a housing, the housing having a durable exterior surface that provides protection to items in an interior of the housing, wherein the housing includes a slotted opening, and at least part of a rewind mechanism is centrally located in the interior of the housing;
a coiled tape that is able to lay flat against a surface when unrolled, the tape having a first side that includes a set of row indicator markings, including a “first row” indicator, for a roofing shingle, the indicator markings being able to indicate to the roofer where to strike chalk lines on the roof for row alignment purposes, wherein the tape further includes an interior end that is attached to the rewind mechanism and an exterior end that at least partially extends outside of the opening in the housing; and,
a nose hook, wherein the nose hook is attached to the exterior end of the tape and includes a section that is complementary in shape to a drip edge of the roof, so that the drip edge is able to completely fit within the nose hook and the nose hook resists becoming unattached from the drip edge even when the tape is pulled upward.

6. The lay-out tape of claim 5, wherein the first row indicator is 12¼ inches from the exterior end of the tape.

7. The lay-out tape of claim 5, wherein the rewind mechanism is an automatic rewind mechanism and the housing includes at least one sliding lock adjacent to the slotted opening that is able to lock the tape in place after the tape has been extended a desired distance through the opening.
